(19) United States
(12) Patent Application Publication
(10) Pub. No.: US 2020/0026800 A1
(43) Pub. Date: Jan. 23, 2020

(54) SYSTEM METHOD AND DEVICE FOR DISCRITIONARY PUBLISH/SEARCH SERVICE BASED ON SECURE IDENTIFIER TECHNOLOGY

(71) Applicant: Project NDI Limited, Hong Kong (HK)

(72) Inventor: HIU FAI SIU, HK (HK)

(73) Assignee: Project NDI Limited

(21) Appl. No.: 16/143,994

(22) Filed: Sep. 27, 2018

(30) Foreign Application Priority Data
Jul. 20, 2018 (CN) 201810802871.3

(51) Int. Cl. G06F 17/30

(52) U.S. Cl. CPC G06F 17/30864; G06F 17/30905; G06F 17/3089

(57) ABSTRACT

System, method and device of discretionary content publishing and discovery in a network environment via the use of a secure global identifier service, where content provider can decide how its content may be published and discovered online, and choose where, which and how to host its content and content discovery service.

### CROSS REFERENCES AND RELATED APPLICATIONS

This application claims priority to Application No. 201810802871.3 filed in China on Jul. 20, 2018, entire contents of which are incorporated by reference herein.

### TECHNICAL FIELD

This invention belongs to the field of network technology. In particular, it defines a method, system and device of a Discretionary Publishing and Search Service (DSS) that allows any individual content provider to decide how and where its content can be published and discovered in a networked environment.

### BACKGROUND

As more and more information become available on the Internet, finding or searching for relevant information and/or content has become an ever-increasing challenge. In this document, we use the word information and content interchangeably. The information may be a depiction of an industrial product, a description of a commercial service, or intellectual works made available over the Internet. Also, in this document, the term content provider refers generally to any individual or entity who desires to post, publish or otherwise place any information on the Internet in any form and manner for any reason or purpose.

Conventional search services on the Internet are host driven. They generally depend on centralized search engine hosts (e.g. GOOGLE), which use traditional web crawlers to index relevant contents on websites. Such approach is disclosed in the following:

Patil, Yugandhara; Patil, Sonal (2016). “Review of Web Crawlers with Specification and Working” (PDF) International Journal of Advanced Research Computer and Communication Engineering. 5 (1): 4.

Kobayashi, M. & Takeda, K. (2000). “Information retrieval on the web”. ACM Computing Surveys. ACM Press. 32 (2): 144-173. doi:10.1145/358923.358934.

Traditional crawler-based information discovery makes no interaction with content providers, and presents the following fundamental challenges:
Content providers have none or little saying on how their content may be indexed and eventually ranked among search results.
As contents change over time, content providers have no means to provide update to the search engine hosts interactively, results in noise and broken links to many search results.
Content discovery is controlled by the search engine hosts, via search algorithm and/or policies deployed by the search engine hosts. In many cases, rankings in search results are based on how much it was paid to the search engine host, but not the relevance of the underlying content.

Different search engine hosts generally work independently from each other. There is no mechanism to help form alliance among different search engine hosts. Instead, search engine hosts have to compete by size in a zero-sum game, and market monopoly is the ultimate outcome. Also, content providers can not actively choose which search engine hosts to publish their content, nor form a community of content publishing and search services among themselves.

The invention disclosed here describes a novel approach that will help overcome these limitations. The invention makes innovative use of a secure global identifier service, to provide accurate and up-to-date descriptions of the underlying content.

In this document, terms “secure global identifier”, “global identifier service” and “globally unique identifier service” are used interchangeably, all references shall include, without limitation, the registration, resolution, and administration of globally unique identifiers and their attributes. By “secure global identifier service”, we mean an identifier-content binding service that, given an identifier, resolves the identifier into description, called attributes, about the content identified by the identifier securely over public Internet. Also, the identifier is registered by the provider of the underlying content, so are the associated attributes that describes the identifier and the underlying content.

The registration and resolution of the identifier is done in a secure fashion where only the content provider has the authority and access to make changes or updates to identifier and its attributes. Attributes resolved from the identifier resolution can be authenticated and protected against any security attack (e.g. spoofing [SPOOFING] and/or man-in-the-middle attack [MAN-IN-THE-MIDDLE]). See, S. Schuckers, Spoofing and Anti-Spoofing Measures, Information Security Technical Report, Vol 7, No. 4 (2002) 56-62, http://php.iai.heigvd.ch/−lzo/biomed/refs/Spoofing%20and%20Anti-Spoofing%20Measures%20-%202002_Schuckers.pdf; and M. Conti, et al. A Survey of Man in The Middle Attacks, IEEE Communications Surveys & Tutorials (Volume: 18, Issue: 3, third quarter 2016).

The secure identifier service must possess the following features and/or characteristics:
Secure resolution and service integrity, where resolution of the identifier must be secure and protected against any network security attack.
Secure registration, where registration of the identifier and identifier information can only be accomplished by responsible content providers, and be protected against fraud and intrusion attack.
Secure and discretionary update and deletion with secure authentication. Under such service, only the content provider, not the hosting service, may have the authority to make update to identifier and identifier attributes.
Distributed and open search architecture, where anyone or any organization can host their own identifier service as an integral component of the global identifier service. All components of the global identifier service must speak the same security protocol for its identifier resolution and administration (i.e. registration, update, and deletion).

The identifier service must define a common access control mechanism in its resolution and administration service, so that owners of the identifiers (i.e. the underlying content provider) may define different roles and accesses for the identifier resolution and administration upon any subset of the identifier attributes. The identifier service must provide a well-defined credential mechanism so that resolution results can be verified and trusted. The identifier service must support any native characters in any native language as defined in Unicode standards.

Furthermore, the identifier service should have a naming scheme that allows easy integration and support of existing naming practice. This identifier service must define an extendable data model that supports any data type or structure for identifier attributes. Owners of the identifier may define their own data type for their identifier attributes and have the data type registered with the identifier service. The Handle System [HANDLE] as developed by the Corporation for National Research Initiatives (CNRI), is one such global identifier service. See, Robert Kahn and Robert Wilensky, “A Frame work for Distributed Digital Object Services’, May 13, 1995. doi:cnridlib/tn95-01); Sam Sun and Lary Lannom, “Handle System Overview”. IETF RFC3650, https://www.ietforg/rfc/rfc3650.txt, November 2003; Sam Sun, Sean Reily and Larry Lannom, “Handle System Namespace and Service Definition”. IETF RFC3651, https://www.ietforg/rfc/rfc3651.txt November 2003; Sam Sun, Sean Reily and Larry Lannom, “Handle System Protocol (ver 2.1) Specification”, IETF RFC3652, https://www.ietforg/rfc/rfc3652.txt, November 2003; and, Corporation for National Research Initiatives (CNRI) http://www.cnri.reston.va.us.

The Handle System is a secure global identifier resolution and administration service with a distributed open service architecture. It provides build-in security mechanisms for service integrity, data confidentiality, and service non-repudiation, and allows discretionary management of its identifier and identifier attributes. The Handle System is a secure global identifier service that consists of a root service cluster, called Global Handle Registry (GHR), and many layers of local handle services (LHS) that can be hosted by any organization to serve its perspective user community.

### SUMMARY

The core of this invention, call it Discretionary Search Service (DSS), is a discretionary information publishing and search system, where content providers, instead of the search engine hosts, manage themselves how the information may be published and discovered.

The system defines a set of service components, and leverages features of a secure global identifier service as described above, to allow content providers to register, publish, and manage their information and information templates, and use such templates in the system to assist the publishing and discovery of their content. Such discretionary search service is a distributed information system, consisting of different kinds of service components described as follows.

A basic service component, which is a service unit hereinafter referred to as the Registry & Search Service (RSS) unit. The RSS is a service component that works directly with any content provider. A content provider may choose to host its own RSS and make his templates available for others to use. The RSS will provide a set of templates, each of which defines a specific structure that allows information to be published and later searched. Content provider may choose to use any of the templates to publish their searchable content as defined by the template, thus makes their content or service discoverable. The RSS may also allow content providers to define and register their own templates and use such templates to facilitate their content discovery. Such templates as defined hereinabove are referred to hereinafter as publish/search templates, or simply templates.

Different RSSs may join together to form an Integrated Search Service (ISS) unit. An ISS is a service component that provides an integrated search interface for the benefit of its member RSSs as well as their users and the general public. ISS will not make changes to the templates as defined in its member RSSs, but instead provides an integrated search interface to help guide any search requests to the appropriate member RSS and the relevant contents.

Different ISSs may further join together to form a higher level of ISS in order to serve a larger community. An ISS may also have a mixture of ISSs and RSSs as its member units as well. All ISSs and RSSs are registered with Search Service Registry, or SSR, a neutral registration service unit that registers every RSS and ISS, each with a global unique identifier. Such registration also maintains the relationships among ISSs and RSSs in terms of perspective identifier attributes.

Every content template and published content based on such template are also registered with a global unique identifier, along with attributes for its authentication and discovery. The SSR may serve as the starting point for identifier resolution and content discovery, for any registered ISSs, RSSs, and their content. There can be as many RSSs and as many (layers) of ISSs as needed. Each ISS or RSS must be registered with SSR.

Content provider may choose to host a RSS itself, and may later choose which ISSs to join with. A content provider may also choose to use an existing RSS and use the templates provided by the RSS to publish its content and manage its discovery. With an existing RSS, a content provider may also create/manage its own set of templates to facilitate its content publishing and search.

The invented search system deploys an open service architecture where any individual or any organization may host its search (and publishing) service (e.g. RSS and/or ISS), and make it an integral part of the global search service. It is also a discretionary search service where search operations are conducted based on the templates defined or chosen by the content provider, instead of hidden algorithms and/or polices set by the search engine host. Content providers will have full management access of their templates and may make updates and adjustments any time to reflect changes of their underlying content.

The invention can also unite different individual search communities into a joint search service. It also allows different search communities to be formed at the discretion of content providers or their relevant RSSs and ISSs, thus provides better service for specific user communities. The system allows better security and access control protection and allows content providers to define what can be found and who can find them from the search service.

Service integrity and accountability measures can also be implemented to provide better trustworthiness from the search service. The invention also allows AI algorithms to be integrated at individual RSS and ISS units to help guide the search operation, without sacrificing security and integrity of the underlying templates. The invention defines an innovative set of methods and uses of secure global identifier service (e.g. the Handle System) to facilitate the registration and management of templates, as well as how the templates may be used in search operations.

### BRIEF DESCRIPTION OF DRAWINGS

FIG. 1 illustrates the way convention search service provide its search service.

FIG. 2 shows the service architecture of the Discretionary Search Service (DSS) in terms of its service components.

FIG. 3 shows the interaction of content provider with RSS to browse and look up for available templates, in order to publish its content.

FIG. 4 shows content provider interacts with RSS to publish its searchable content via registered templates at the RSS.

FIG. 5 shows content provider to create self-defined templates and have them registered with the RSS.

FIG. 6 shows end-users interact with RSS via its public search interface to search for any published information.

FIG. 7 shows the integration of RSSs and ISSs into higher level of ISS, in order to provide more comprehensive search service for potentially larger user community.

FIG. 8 shows the ISS and its public search interface for general public users.

FIG. 9 shows the SSR registration interface for RSSs and ISSs and public search interface for general public users.

### DETAILED DESCRIPTION

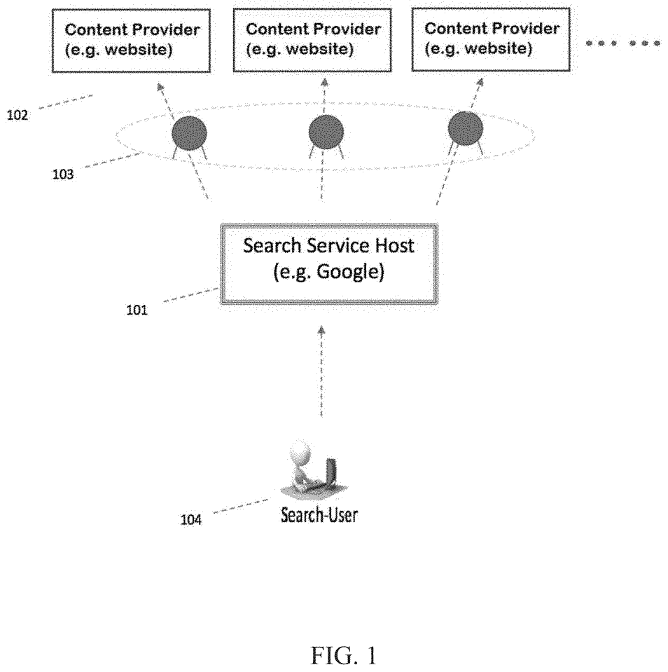

Conventional search services generally depend on certain forms of Web Crawlers to collect information on the web. This is illustrated in FIG. 1 where traditional search service host (e.g. Google) 101 collect information from every content provider's website 102 via so-called web-crawler 103. The search engine 101 then indexes such collected information and maintains the index in its local database. Search requests from any search-users 104 are answered based on such index, as well as local policies deployed by the search service 101.

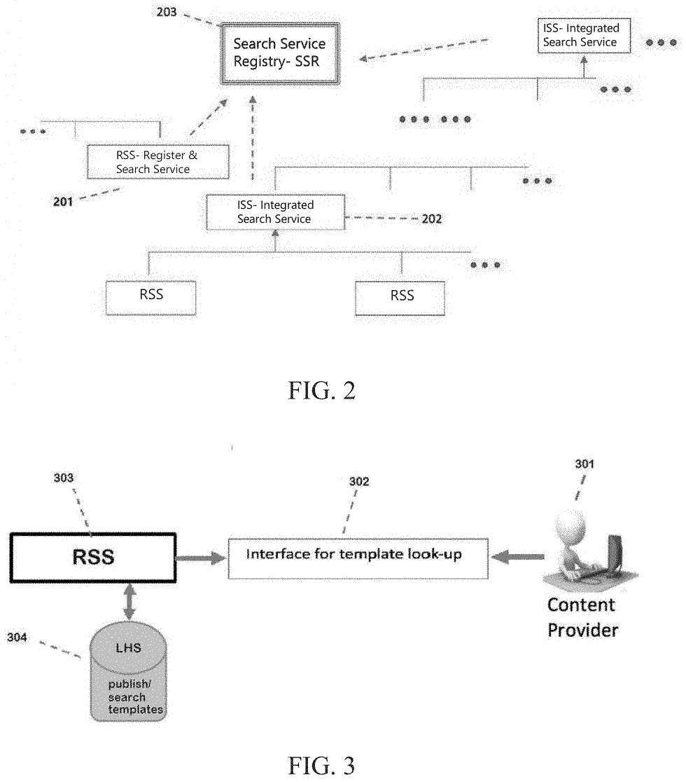

FIG. 2 shows the architecture of DSS. As shown in FIG. 2, DSS consists of three kinds of service component units, the Registry & Search Service unit—RSS 201, the Integrated Search Service unit—ISS 202, and the Search Service Registry unit—SSR 203. Each RSS 201 and ISS 202 are registered with SSR 203 using a global unique identifier service. The identifier comes with attributes that can be used to describe the service components, including their authentication information, as well as their relationship with other service components. The host or owner of RSS 201 or ISS 202 will have total management control of the identifier and its attributes.

The SSR 203 provides registration services for every RSS and ISS service component units. The SSR 203 may also provide comprehensive search interface for the discovery of relevant ISS and/or RSS, and refer search-users to the appropriate search service components. The Discretionary Search Service as described in FIG. 2 presents an open service architecture, where any organization or individual can host its own RSS 201 or ISS 202 service. Content providers are free to choose their preferred RSSs to use templates provided, or to host their own templates, and provide search service for their content. Individual RSS 201 and ISS 202 may also join together to form a new service unit of ISS 202 and provide a more comprehensive search service with a larger content base.

FIG. 3 shows interaction of content provider 301 with RSS 303 to browse or lookup for templates that can be used for publishing his content. In FIG. 3, RSS 303 provides a template lookup interface 302, that allows content provider 301 to browse the collection of templates registered at the RSS. The RSS stores its collection of templates in its local identifier service (e.g. LHS) 304, and makes them available for lookup through the above interface 302.

Any publish/search template will be registered and identified with a globally unique identifier via the global identifier service. Such templates may be defined in terms of XML, JSON or YANG language. Publish/search templates are stored as identifier attributes. The administrator of the identifier is the one who created the template, and will have full management control of the template.

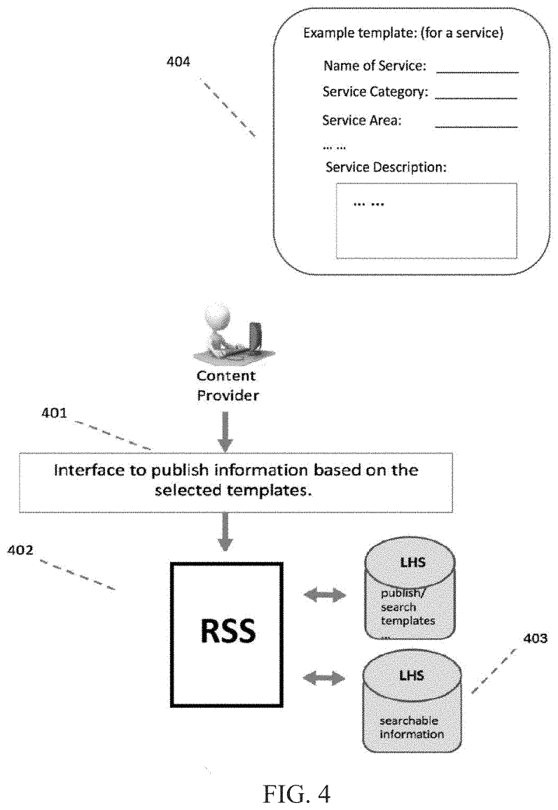

FIG. 4 shows content provider interacts with RSS to publish its searchable information via RSS. In FIG. 4, RSS 402 provides an interface 401 that allows any content provider to publish his content using selected template. Such published information is then registered with a unique identifier and stored and indexed via the local identifier service (e.g. LHS) 403 of the RSS.

Content providers may browse through the collection of templates from a RSS, and choose the desired template to publish his information. Such published information may lead to a content repository or online service/application hosted by the content provider, or explain a service or a product that the content provider wants to make available. Content providers can freely choose any RSS to publish their searchable information. They can also select any templates provided by RSS that best serve their purpose.

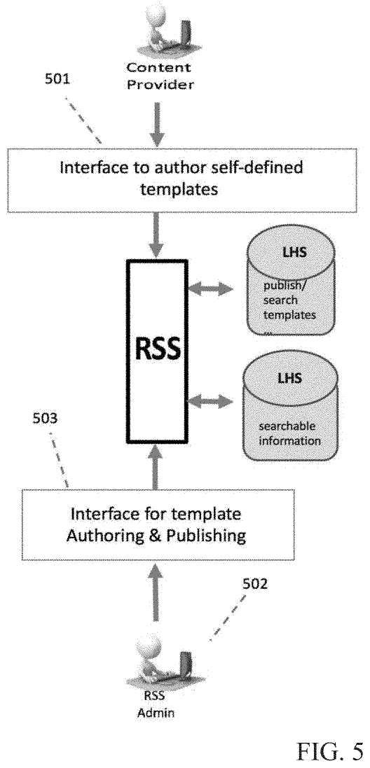

FIG. 5 shows content provider to interact with RSS, or SSR if no suitable RSS is available for interaction, to create self-defined templates. This may happen in situations where content provider cannot find any adequate templates to publish its content and decide to create/design his own template. In FIG. 5, content provider creates his own template with the template authoring interface 501 provided by the RSS. The RSS administrator 502 will examine such templates via the RSS admin-interface 503. Once accepted, such templates will be given a global unique identifier and registered in the RSS's local identifier service storage (e.g. LHS). Where there is no suitable RSS to register the self-defined templates with, SSR may guide the self-defined template owner to either create and host its own RSS, or to find an existing RSS to host the template. Note that any organization can host a RSS, and content-providers has the freedom to choose any RSS hosted by any organization.

Every template under RSS is given a global unique identifier, so is every owner of such templates. The owner or the administrator of the template may make changes or remove the template upon successful authentication with the RSS.

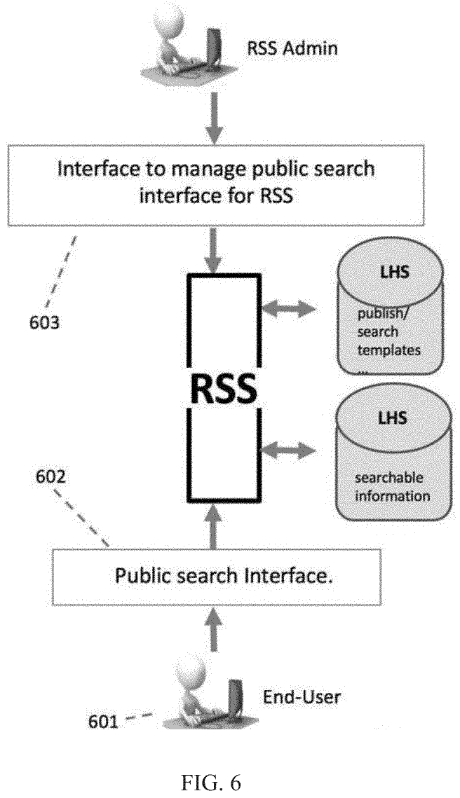

FIG. 6 shows RSS providing its search service to the general public, via its public search interface. In FIG. 6, end-users 601 may start its search operation via the public search interface 602 provided by the RSS. The RSS administrator may make changes to the public search interface via the RSS management interface 603, in order to provide better user experience. The RSS public search interface 602 is template oriented. Users can either look up a template to publish their contents, or look for a published content through information about that content registered with the RSS through the template used for the content's publication; the RSS administrator is responsible to provide user-friendly guidance based on its collection of templates upon any public search request.

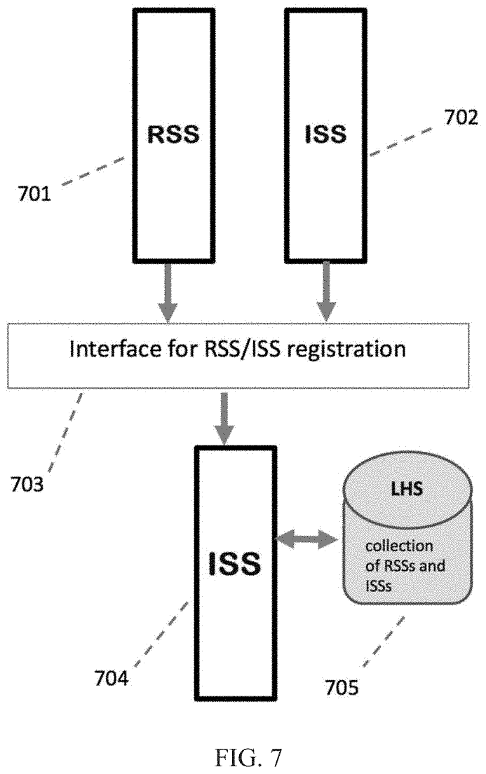

FIG. 7 shows how an RSS 701 may join an ISS 704, in order to establish a more comprehensive search service. In FIG. 7, RSS 701 may join an ISS via its RSS/ISS registration interface 703. Once approved, the ISS will store such registered RSS in its local identifier service storage (e.g. LHS) 705, and include the RSS as part of its comprehensive search service. Similarly, an ISS 703 may also elect to join another ISS 704 to establish or be part of a more comprehensive search service. Each RSS and ISS are registered and can be identified with a global unique identifier. The RSS/ISS administrator may manage the identifier attributes to reflect the relationship among these RSSs and ISSs.

ISS 704 provides an integrated search interface based on its collection of registered RSSs and ISSs. Note that ISS 704 cannot make any changes to any of the registered templates. Templates are managed by RSSs and can only be modified and changed by the template owner/administrator.

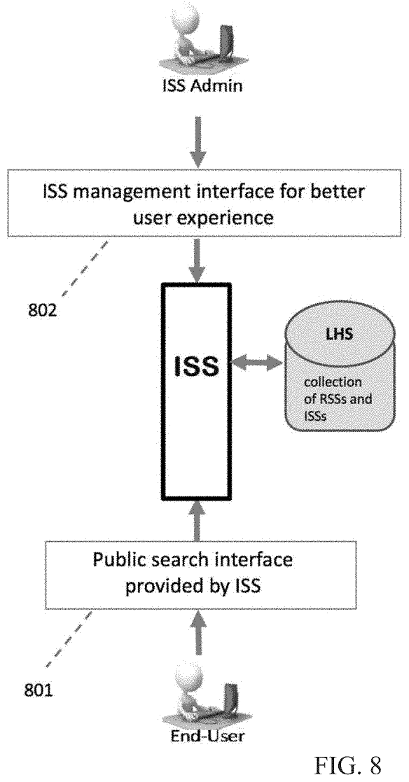

FIG. 8 shows ISS providing its search service to the general public, via its public search interface. In FIG. 8, end-users may start its search operation via the public search interface 801 provided by the ISS. The ISS administrator may make changes to the public search interface via the RSS management interface 802, in order to provide better user experience. The ISS public search interface 801 is template oriented, in the same way as the RSS pubic search interface. The ISS administrator is responsible to provide user-friendly guidance based on its collection of templates upon any public search request.

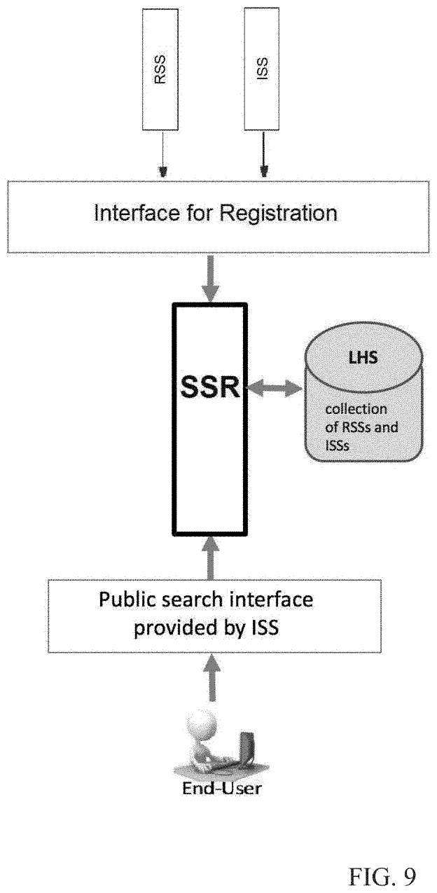

FIG. 9 shows SSR providing public search service to the general public via its public search interactive interface, and providing registration service to ISSs and RSSs through its registration interface.

Search interfaces provided by RSS, ISS and local search interface provided by content provider, subject to the discretion and choice of their owners/administrators, can contain the reference to the generic search interface provided by the SSR. Any search request from user may be directed to the SSR public search interface.

Furthermore, DSS applies the blockchain technology to implement data transmission and transaction among RSS, ISS, SSR, and the service community formed by above service components. Thus, the blockchain provides credibility for publishing information in the service community formed by above service components.

The invention claimed is:

1. An Internet discretionary information publishing and search system that consists of at least one or any combination of the following service component units:
a. the Registration and Search Service unit (“RSS”)—a content publishing and search service component unit that interacts directly with content providers; each RSS defines and registers one or more templates for the publishing of content and makes such templates available for use by content providers to register, publish their contents and manage subsequent search and discovery of the published content; content search users can search for content by searching for registered information of the templates, including information about the content that are self-defined by the content provider; each RSS is registered with a Search Service Registry unit with one or multiple unique identifiers via a global identifier service, which unique identifiers contain public key information to be used in the secured exchanges between the RSS and its users; each RSS can run a local identifier service and register identifiers for every template registered by the RSS and every content published using such registered templates;
b. the Integrated Search Service unit(“ISS”)—an aggregated search service component formed by aggregating at least two individual search service units (e.g. RSS, ISS) in any combination, to provide a more comprehensive search service; each ISS is registered with the Search Service Registry with one or multiple unique identifiers, via the use of a global identifier service, which identifiers contain public key information for secured exchanges among the ISS and its users; all ISSs can also run local identifier services for the registration of identifiers for each aggregated RSS and ISS.
c. the Search Service Registry unit (“SSR”)—SSR provides a registration service for RSSs and ISSs and at the same time provides an integrated search service for all RSSs and ISSs it has registered; the SSR is identified by unique identifiers via the use of a global identifier service, which unique identifiers contain public key information used for the secured exchanges among SSR, RSSs and ISSs as well as their respective users; SSR can also run its local identifier service to register identifiers for RSSs and ISSs.

2. An Internet discretionary information publishing and search system according to claim 1, wherein every RSS and ISS unit has a registration interface whereby a RSS unit can join an ISS unit, and two or more ISS units can join each other to form an ISS unit.

3. The discretionary information publishing and search service system as claimed in claim 1, which uses the block chain technology to implement data transmission among the Registry and Search Service unit, the Integrated Search Service unit, the Search Service Registry unit, and the service community formed by the above units, and wherein the block chain provides credibility for publishing information in the service community formed by the Registry and Search Service unit, the Integrated Search Service unit, and the Search Service Registry unit.

4. An Internet discretionary information publishing and search system according to claim 1, wherein the RSS units provide for:
a. A template lookup interface, for content providers to look up templates made available at the RSS;
b. A content publishing interface, for content providers to publish information based on a selected template;
c. A template authorizing interface, for content providers to define templates they need but not available at the RSS concerned, whereby a template self-defined by one content provider can be used by other content providers after it is registered with and made available by the RSS; and whereby the template defined by a content provider and made available at a RSS can be modified by that content provider; and,
d. An interactive administrator interface, whereby administrators of RSSs can release templates and make them available at the RSSs.

5. The system according to claim 1, wherein the SSR unit provides:
a. a registration interface, for RSSs and/or ISSs to get registered and connected;
b. a public search interface, for provision of a comprehensive search service to the general public;
c. an administration interface, for the SSR administrator to modify the public search interface or release templates;
d. a template authoring interface, for a content provider to define its own template when there is no suitable template available, which self-defined template can be made available for use by other users;
and wherein the templates released at the SSR unit are registered and identified via the use of a globally unique identifier service.

6. An Internet discretionary information publishing and search system according to claim 1, wherein each ISS unit provides a public search interface, for provision of public search service to the general public, and an interactive administrator interface, for use by the ISS administrator to modify the public search service interface provided by that ISS.

7. An Internet discretionary information publishing and search system according to claim 2, wherein every RSS unit includes, inter alia, a public search interface, for the provision of search service to the general public; and wherein the interactive administrator interface can also function to allow the RSS administrator to modify the public search interface the RSS provides.

8. The system according to claim 2, wherein each RSS makes available at least one template for use by content providers to define the manner in which the specific content being published can be searched upon and discovered.

9. The system according to claim 2, wherein each RSS unit and each ISS are registered with the SSR unit via the use of a globally unique identifier service, with globally unique identifiers whose attributes containing, without limitation, authentication information of the service unit concerned and information about its relationship with other component service units; and wherein the SSR unit provides a public search service as the ultimate starting point for any end user desirous of conducting a search.

10. The system according to claim 2, wherein all templates released in each RSS are registered or identified via the use of a globally unique identifier service; and wherein contents published by content providers are also registered via the use of a globally unique identifier service, stored, and indexed and discovered through the local identifier service run at the RSS unit concerned.

11. The system according to claim 4, wherein each RSS makes available at least one template for use by content providers to select from choices provided by the template to customize discovery of the content when searched upon, which shall include without limitation: to prescribe which part of the content can be searched and discovered and by who, the channel or method, etc., by which it can be searched and discovered, as well as the way and manner in which the content can be utilized by search users.

12. The system according to claim 6, wherein the SSR unit provides a public search service to end users of the general public as the ultimate search starting point, such public search is based on/guided by or otherwise oriented to the templates used by content providers when publishing the content at a given RSS unit.
